(19) United States
(12) Patent Application Publication
(10) Pub. No.: US 2010/0094944 A1
(43) Pub. Date: Apr. 15, 2010

(54) STORAGE MEDIUM STORING SYSTEM ANALYSIS SUPPORT PROGRAM, SYSTEM ANALYSIS SUPPORT SYSTEM, AND SYSTEM ANAYLSIS SUPPORT METHOD

(75) Inventor: Naoki AKABOSHI, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/555,174

(22) Filed: Sep. 8, 2009

(30) Foreign Application Priority Data
Oct. 14, 2008 (JP) 2008-265695

(51) Int. Cl. G06F 15/16; G06F 17/30

(52) U.S. Cl. 709/206; 707/E17.014

(57) ABSTRACT

A system analysis support system supports analysis of status of operation of a network system. A storage unit stores an actual processing time taken by a server at a destination of a request message. When the response message is not found as a result of the search, a decision unit reads the actual processing time and makes a decision from an instant of sending of the request message as to whether or not the actual processing time for the request message has elapsed. When the actual processing time is judged to have elapsed, a determination unit determines an estimated instant of sending based on the instant of sending of the request message and on the actual processing time on the assumption that the response message has been sent. An associating unit associates the determined estimated instant of sending with the request message. An output unit outputs results of the association.

### CROSS-REFERENCE TO RELATED APPLICATIONS

This application is based upon and claims the benefit of priority of the prior Japanese Patent Application No. 2008-265695, filed on Oct. 14, 2008, the entire contents of which are incorporated herein by reference

### BACKGROUND

1. Field

This embodiment(s) discussed herein relate to a technique for assisting in analyzing a status of operation of a network system and system implementing the same.

2. Description of the Related Art

Current IT (information technology) systems assume the responsibility of supporting the social infrastructure. Therefore, it is essential that IT systems operate stably for 24 hours per day throughout the year. Furthermore, as IT businesses grow, the IT systems have been required to offer higher quality of services, as well as continual stable operation. Consequently, it is important that the quality of services experienced by end users be monitored from the viewpoint of the end users.

On the other hand, in an IT system where plural applications operate in cooperation, it is necessary to observe and analyze the performance of the whole system as well as the behavior of each server, in order to locate causes of performance deterioration and faults. Hence, it has become more difficult to precisely grasp the status of operation of complicated, ever larger scaled IT systems and performance issues (such as poor performance relative to load).

In the typical art, various techniques for analyzing the status of operation of each IT system have been disclosed. For example, there is a system visualization technique which analyzes messages passed within a system of interest for each service, creates a transactional model, and observes and analyzes the performance of the whole system. This system visualization technique uses a transactional model in which a request message and a response message are represented as a pair. Therefore, a transactional model is created or the status of operation of the system of interest is analyzed on the assumption that there is a response relative to a request.

However, if processing produces no response after a lapse of a given time, an application operating in the system of interest detects the processing as having timed out. In this case, any response message responsive to a request message is neither issued nor present. Accordingly, the typical system visualization technique has the problem that it is difficult to grasp how transactions including timeouts are being processed. This will lead to deterioration of the accuracy at which the status of operation of the system of interest is analyzed.

On the other hand, in a case where processing producing no response after a lapse of a given time is not detected as having timed out in order to grasp the status of processing of a transaction, there is the problem that the user continues to wait for arrival of a response relative to a request. This will deteriorate the quality of service experienced by the end user. This will give rise to deterioration of the quality of the service that the system of interest can offer.

The disclosed technique is intended to improve upon and address existing problems including the accuracy at which the status of operation of a system of interest is analyzed by precisely grasping the status of processing of transactions including timeouts, in order to eliminate the problems with the aforementioned typical art.

### SUMMARY

A system analysis support system and method supports analysis of status of operation of a network system in which plural servers operate in cooperation. A storage unit stores an actual processing time taken by a server at a destination of a request message passed within the network system. A search unit searches message data sets passed within the network system for a response message responsive to the request message. When the response message is not found as a result of the search, a decision unit reads the actual processing time from the storage unit and makes a decision from an instant of sending the request message as to whether or not the actual processing time for the request message has elapsed. When the actual processing time is judged to have elapsed, a determination unit determines an estimated instant of sending based on the instant of sending of the request message and on the actual processing time on the assumption that the response message has been sent. An associating unit associates the determined estimated instant of sending with the request message. An output unit outputs results of the association.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a schematic diagram of a general three-layer hierarchical system;

FIG. 2 is a diagram illustrating a configuration of an IT system;

FIG. 3 is a schematic diagram illustrating a capturing function;

FIG. 4 is a block diagram showing a hardware configuration of a system analysis support system;

FIG. 5 is a diagram illustrating one example of content stored in a message buffer;

FIG. 6 is a diagram illustrating one example of content stored in a supplementary data table;

FIG. 7 is a block diagram showing a functional configuration of a system analysis support system;

FIG. 8 is a diagram illustrating one example of content stored in a pair data table;

FIG. 9 schematically illustrates an update process;

FIG. 10 is a first flowchart illustrating one example of a procedure for processing for system analysis support;

FIG. 11 is a second flowchart illustrating an example of a procedure for processing for system analysis support;

FIG. 12 is a flowchart illustrating one specific example of procedure for processing of an update process;

FIG. 13 is a third flowchart illustrating an example of a procedure for processing for system analysis support;

FIG. 14 is a diagram illustrating a specific example of a transaction including a timeout;

FIG. 15 is a diagram illustrating an example of generation of a transactional model; and

FIG. 16 is a diagram illustrating a specific example of matching results.

### DETAILED DESCRIPTION OF EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

The preferred embodiments of the disclosed technique are hereinafter described in detail by referring to the accompanying drawings. The disclosed technique analyzes status processing of transaction(s) including timeouts by complementing an instant of a response from the actual processing time taken by a server at a request destination in a case where there is no response and building a correspondence relationship between the instant of request and the instant of response.

First, the present technique for supporting a system analysis is described briefly. In the following description, problems with the typically used technique are first explained. Then, a method of solving the problems by the present technique is described briefly. In the well-known technique for visualization of a system, messages passed within the system of interest are analyzed, and a transactional model is created for each business service. The transactional model defines messages passed within the system during execution of a transaction associated with the business services.

Business services include, for example, making bank deposits, making balance inquiries, sending money from the bank, and placing money into the account from other than the bank, all by online banking. For example, when business services for making bank deposits are offered, a transactional model for a transaction for making bank deposits defines messages passed within the system.

In the system visualization technique, messages passed within the system are matched against the transactional model, thus analyzing the status of processing for each business service. For example, the processing time taken by each server within the system when the services for making bank deposits are offered is analyzed using a transactional model for transactions for making bank deposits.

In the typical transactional model, a request message and a response message are expressed as a pair. Accordingly, the aforementioned operations are performed on the assumption that a request message and a response message are paired.

However, some applications operating within the system operate in such a way that any processing producing no response after a lapse of a given time is detected as a timeout. In this case, it follows that any response message responsive to a request message does not exist. Consequently, the typical technique cannot treat this case.

Timeouts take place, for example, due to poor performance of the server relative to the load or due to increase in the traffic of communication. Furthermore, timeouts affect the quality of business services experienced by the end users. If timeouts occur frequently, the quality is deteriorated severely. Therefore, it is important that transactions including timeouts be precisely grasped and that capacity planning of the system be done. Circumstances where timeouts take place in a general three-layer hierarchical system are described below.

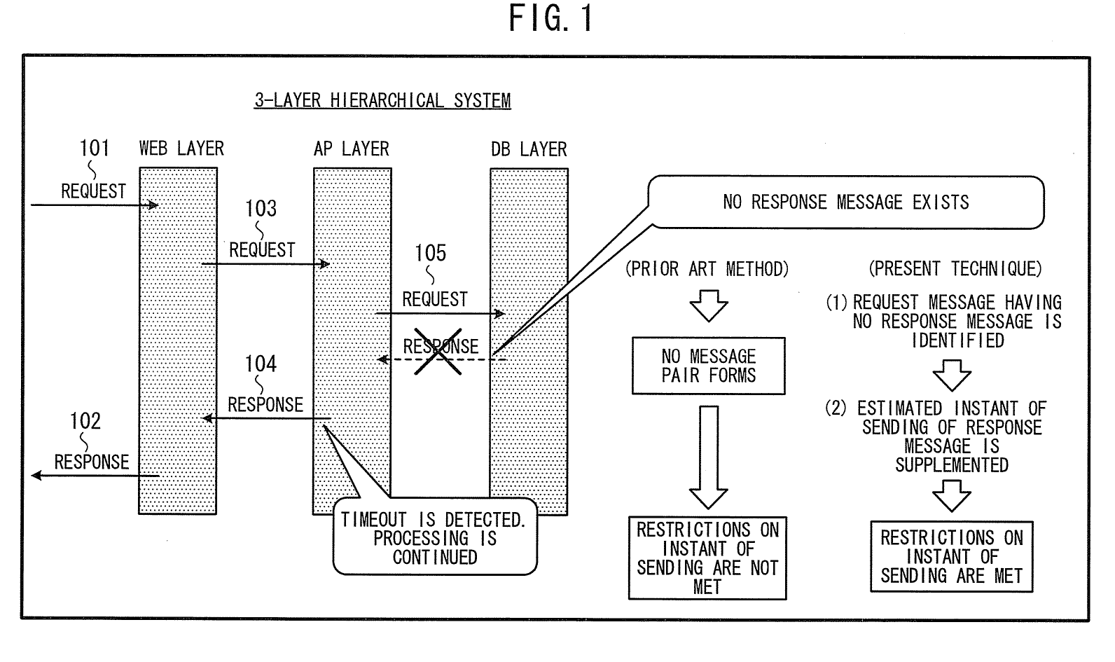

FIG. 1 is a schematic diagram of a general three-layer hierarchical system. In FIG. 1, the three-layer hierarchical system is designed to be split into three layers, i.e., a Web layer, an AP (application) layer, and a DB (database) layer. This system is used as a system for offering various kinds of business services, for example, an online banking.

Where the aforementioned operation is performed by the typical technique, the nesting relationship of paired messages between layers of hierarchy based on the calling/called relationship of processing is judged. The calling/called relationship of processing refers to processing performed by an upper layer of hierarchy (e.g., the Web layer) calls processing performed by a lower layer of hierarchy (e.g., the AP layer) but the reverse does not hold.

That is, the system is based on the assumption that paired messages in a higher layer of hierarchy encompass paired messages in a lower layer of hierarchy. The system is based on the assumption that a request message 103 in the AP layer and a response message 104 are sandwiched between a request message 101 in the Web layer and a response message 102. More specifically, with respect to instants of sending T1, T2, T3, and T4 at which the messages 101-104 are respectively sent, it is necessary that restrictions on the instants of sending indicated by “T1<T3” and “T4<T2” need to be met. The restrictions need to be satisfied also between the AP layer and the DB layer.

However, in the example of FIG. 1, any response message responsive to a request message 105 is not available even after a lapse of a given period. Therefore, the AP layer detects a timeout of the DB layer and the processing is made to proceed. In this case, any response message responsive to the request message 105 does not exist and so the restrictions on the instants of sending based on a message pair are not satisfied. Therefore, in the typical technique, the operation described above cannot be performed. Consequently, it is impossible to grasp the status of processing of transactions including timeouts, i.e., the status of processing of business services when a timeout has occurred.

Accordingly, in the present technique, a request message for which any response message responsive to the request message does not exist is identified from messages passed within a system of interest. Using the actual time taken by a server at the request destination to perform processing, an estimated instant (a point of time) of sending of a response message that does not exist in practice but would be paired with the request message is supplemented.

In consequence, even with respect to request messages having no response messages, it is possible to build a correspondence relationship between request instant and response instant. As a result, it is possible to judge the restrictions on the instants of sending of message pairs. Hence, the status of processing of a transaction which is performed from the request message 101 to the response message 102 and which includes a timeout can be grasped.

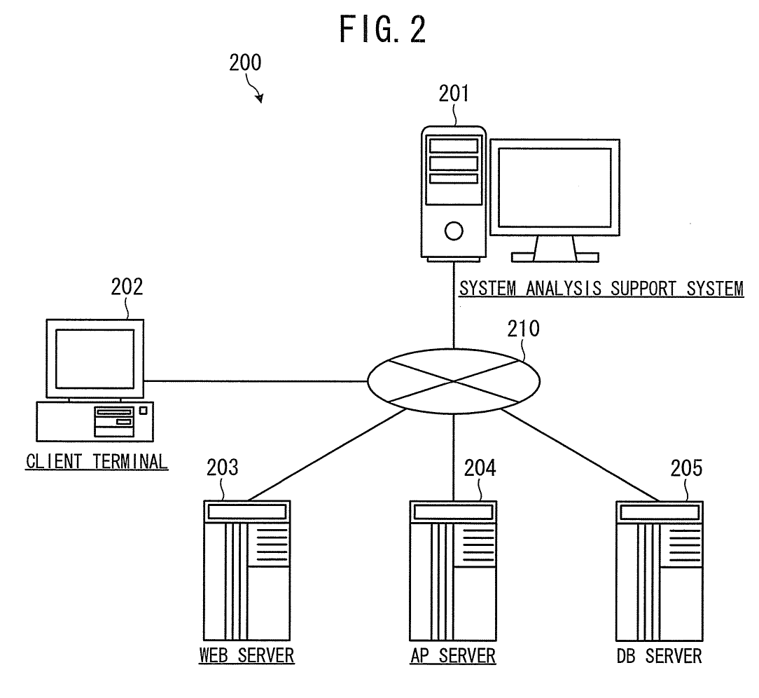

The configuration of the IT system associated with an embodiment is next described. FIG. 2 is a diagram illustrating a configuration of the IT system. In FIG. 2, a system analysis support system 201, client terminal(s) 202, Web servers 203, AP servers 204, and DB servers 205 are interconnected via a network 210 (such as the Internet, a LAN (local area network), or a WAN (wide area network)) in the IT system 200. For simplicity of the illustration, with respect to each type of device of the client terminals 202, Web servers 203, AP servers 204, and DB servers 205, only one is shown.

The IT system 200 is a three-layer hierarchical system (see FIG. 1) in which a hierarchical structure of protocols is defined. In particular, Hypertext Transfer Protocol (HTTP) that is the protocol used in communications between the client terminals 202 and the Web servers 203 is defined in the Web layer.

IIOP (Internet Inter-ORB Protocol) that is the protocol used in communications between each Web server 203 and each AP server 204 is defined in the AP layer. SQL (Structured Query Language) (database language) that is the protocol used in communications between each AP server 204 and each DB server 205 is defined in the DB layer.

The system analysis support system 201 has a function of capturing messages passed within the IT system 200. Furthermore, the support system 201 has a function of assisting in analyzing the status of operation of the IT system 200. The Web servers 203, AP servers 204, and DB servers 205 offer business services such as online banking services in response to requests from the client terminals 202.

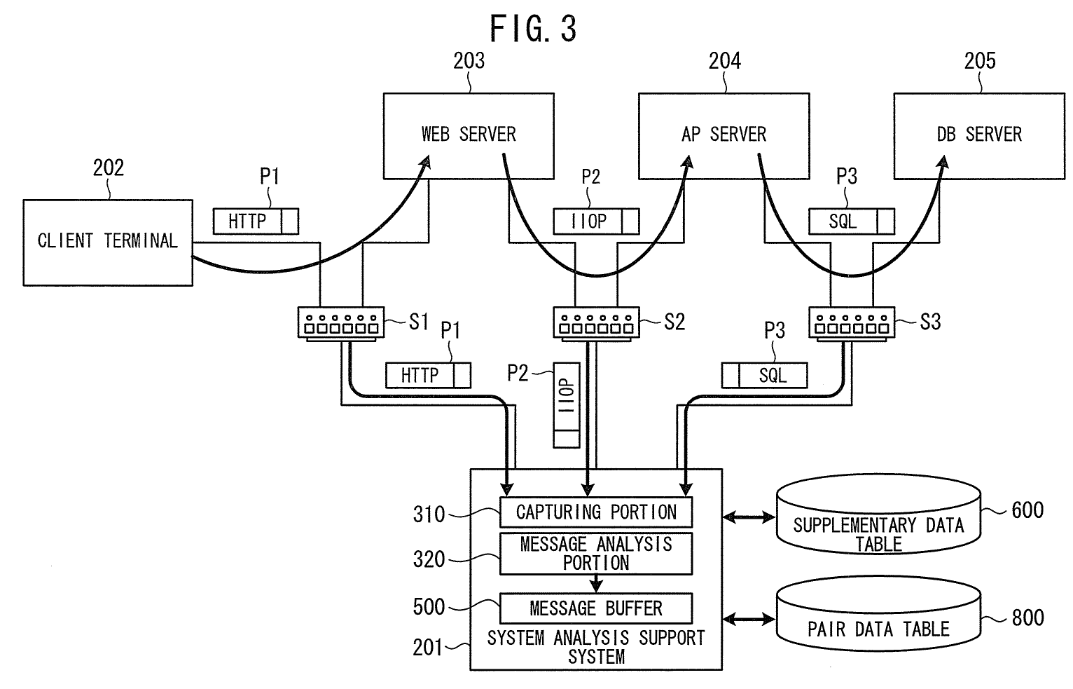

The capturing function of the system analysis support system 201 associated with an embodiment is next described. FIG. 3 is a schematic diagram illustrating a capturing function. In FIG. 3, the function(s) of capturing packets P1-P3 of various protocols (HTTP, IIOP, and SQL) passed within the IT system 200 are schematically illustrated.

The system analysis support system 201, client terminal 202, Web server 203, AP server 204, and DB server 205 are connected with individual ports of switches S1-S3 mounted inside the network 210. The switches S1-S3 have a function of mirroring data passing through them. That is, data identical with data output at some port is output from other port.

In an embodiment, a port to which the system analysis support system 201 is connected is designated as a mirror destination of the port with which the Web server 203, AP server 204, and DB server 205 are connected. Therefore, packets destined for each server are entered into the destination servers and also into the system analysis support system 201.

As an example, it is assumed that the Web server 203, AP server 204, and DB server 205 operate in cooperation in response to a request from the client terminal 202 to offer services. In this case, the packet P1 is sent from the client terminal 202 to the Web server 203.

At this time, another packet P1 having the same content as the previously described packet P1 is entered into the system analysis support system 201. Then, if the packet P2 is sent from the Web server 203 to the AP server 204, another packet P2 having the same content as the previously described packet P2 is entered into the system analysis support system 201. Furthermore, if the packet P3 is sent from the AP server 204 to the DB server 205, another packet P3 having the same content as the previously described packet P3 is entered into the system analysis support system 201.

The packets P1-P3 entered into the system analysis support system 201 are acquired by a capturing portion 310 directly connected with the switches S1-S3. The packets acquired by the capturing portion 310 are subjected to message analysis by a message analysis portion 320. The message analysis may be the same as the typical system and so its description is omitted.

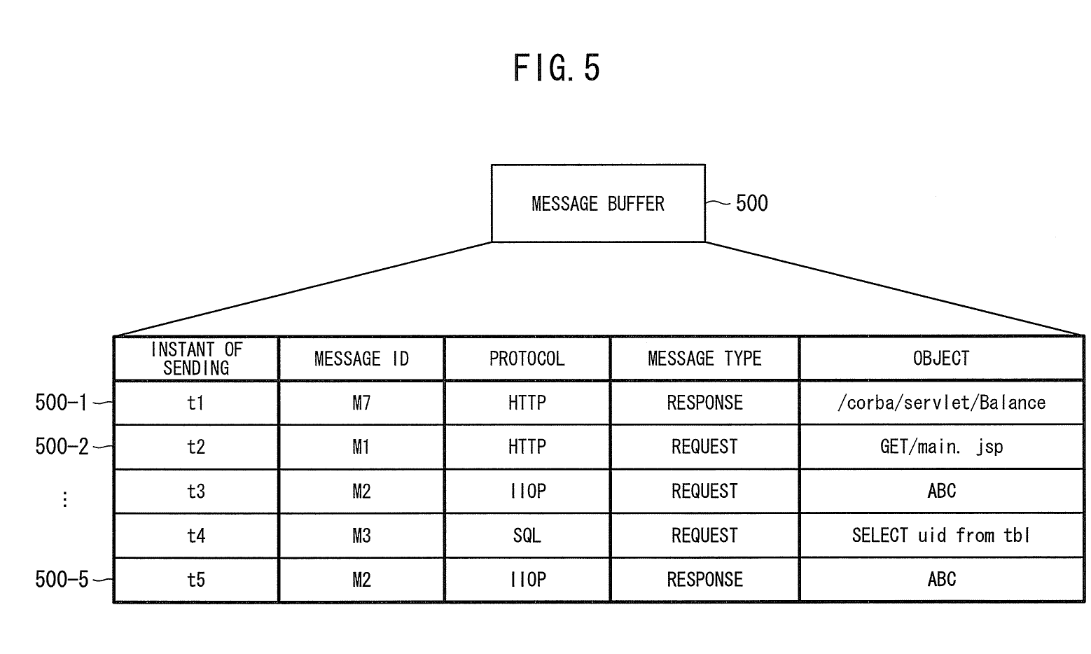

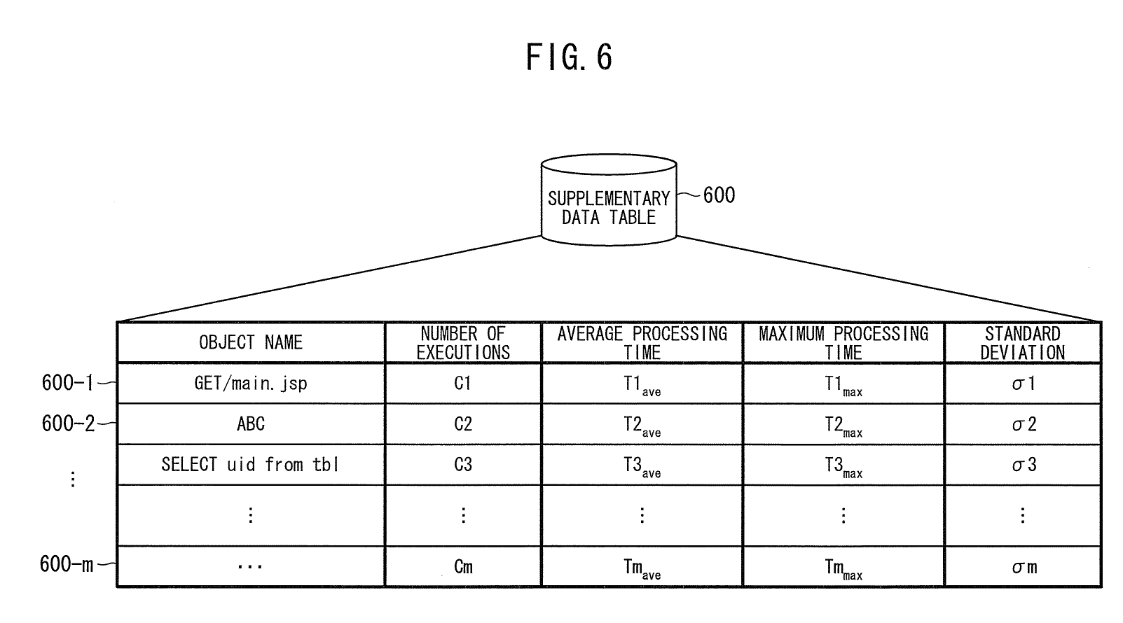

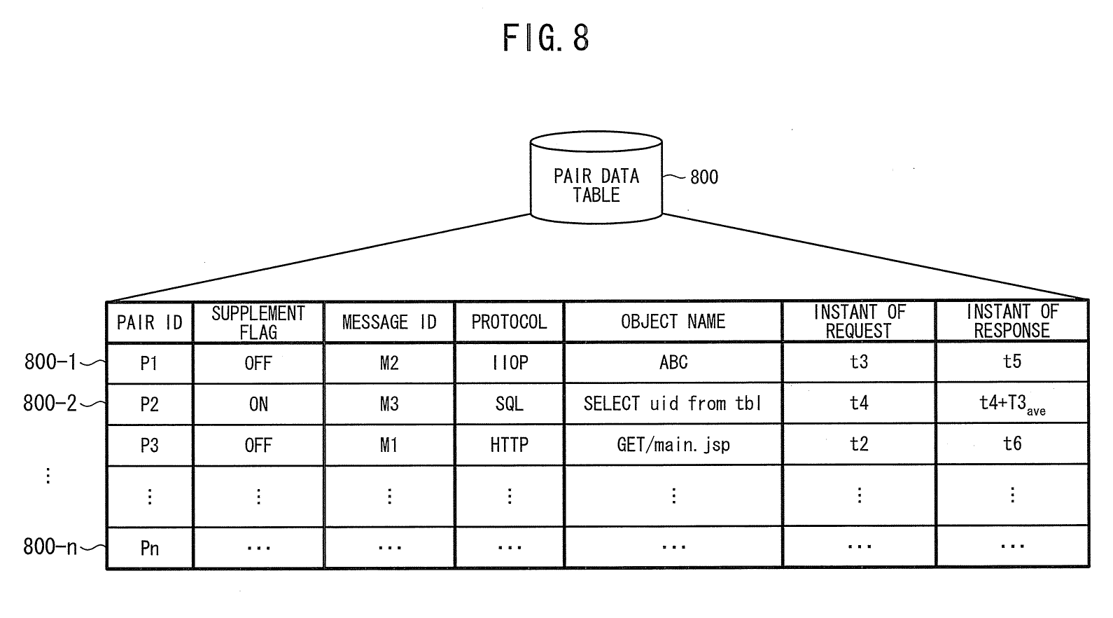

The results of the analysis are stored, for example, in a message buffer 500 shown in FIG. 5. The system analysis support system 201 can gain access to a supplementary data table 600 in which complementary data sets 600-1 to 600-m are stored as described later in connection with FIG. 6. Furthermore, the support system 201 can gain access to a pair data table 800 in which pair data sets 800-1 to 800-n are stored as described below in detail in connection with FIG. 8.

The capturing function makes it possible to collect messages passed within the IT system 200 without affecting the services being carried out. The capturing portion 310 may capture only arbitrary packets (such as packets forming synchronized packets). Furthermore, only necessary data may be selected by the switches S1-S3 and mirrored.

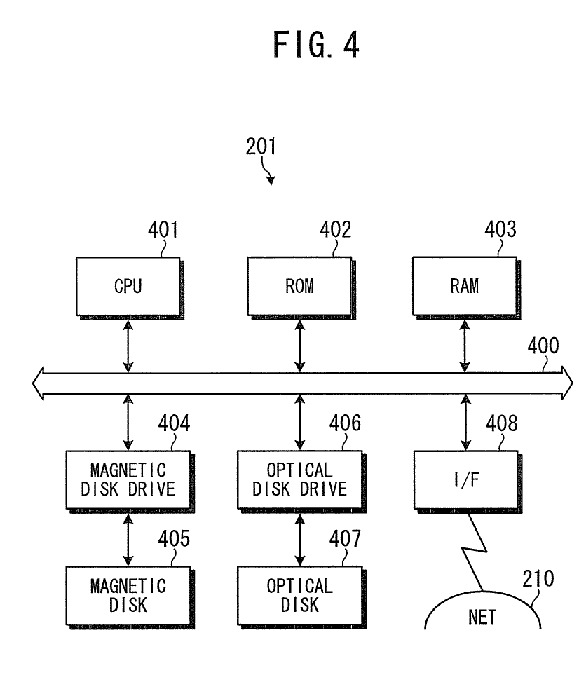

The hardware configuration of the system analysis support system 201 associated with an embodiment is next described. FIG. 4 is a block diagram showing a hardware configuration of the system analysis support system. In FIG. 4, the support system 201 has a CPU (central processing unit) 401, a ROM (read-only memory) 402, a RAM (random access memory) 403, a magnetic disk drive 404, a magnetic disk 405, an optical disk drive 406, an optical disk 407, and an I/F (interface) 408. These components are connected by a bus 400.

The CPU 401 controls the whole system analysis support system 201. A program such as a boot program is stored in the ROM 402. The RAM 403 is used as a working area of the CPU 401. The magnetic disk drive 404 controls reading and writing of data to and from the magnetic disk 405 under control of the CPU 401. The data written under control of the magnetic disk drive 404 is stored on the magnetic disk 405.

The optical disk drive 406 controls reading and writing of data to and from the optical disk 407 under control of the CPU 401. The optical disk 407 stores the data written under control of the optical disk drive 406 or permits data stored on the optical disk 407 to be read by a computer.

The interface (abbreviated I/F) 408 is connected with the network 210 such as a LAN, a WAN, or the Internet via a communication network. The interface is connected with other devices such as the switches S1-S3 via the network 210. The I/F 408 controls the network 210 and internal interfaces and provides control of inputting and outputting of data to and from external devices. A modem or a LAN adapter, for example, can be used as the I/F 408.

The hardware configuration of the system analysis support system 201 has been described so far. The client terminal 202, Web server 203, AP server 204, and DB server 205 can be realized with similar hardware configuration. In the following description, the Web server 203, AP server 204, and DB server 205 are simply referred to as the servers 203-205 unless otherwise specifically stated.

The contents of the message buffer built in storage areas such as the magnetic disk 405 and optical disk 407 shown in FIG. 4 are next described in detail. FIG. 5 is a diagram illustrating one example of content of the message buffer. In the figure, only parts of the message data stored in the message buffer are extracted and displayed.

Referring to FIG. 5, the message buffer 500 has fields for the instants of sending of messages, message IDs, protocols, message types, and objects. Message data sets 500-1 to 500-5 passed within the IT system 200 are stored as records by setting information in each field.

The instants of sending are the instants at which messages are sent from the client terminal 202 or from the servers 203-205. The messages include request messages and response messages. Each request message is used to ask for given processing or data provision. Each response message is used to make a response to a request made using a request message.

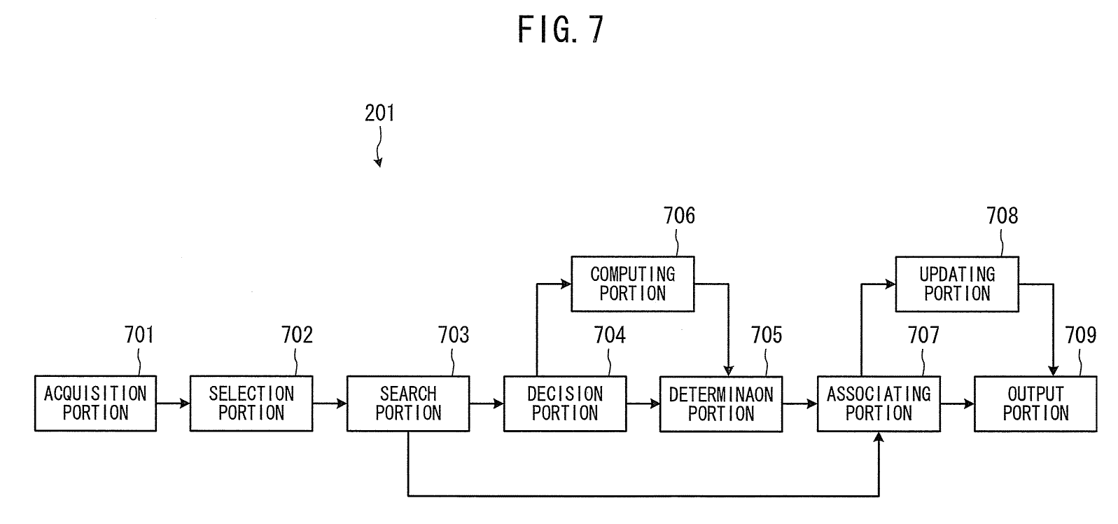

Each message ID is an identifier for identifying a message. In an embodiment, the same message ID is given to messages which make a pair and which have a correspondence relationship. Therefore, functional portions (such as selection portion 702 and search portion 703) described below in detail in connection with FIG. 7 can recognize a request message and a response message having a corresponding relationship by referring to their message IDs.

Each protocol is used to permit a message to be passed. Accordingly, the functional portions can recognize the client terminals 202 or servers 203-205 at the message sender and at the destination by referring to the protocol. Each message type is information for identifying a request message or response message. Each object is one or more processes performed during an interval beginning with the instant which the servers 203-205 receive a request message and ending with the instant at which they send a response message.

Take the message data set 500-2 as an example. The functional portions can recognize a request message M1 sent from the client terminal 202 to the Web server 203 by referring to the information set in each field. The message buffer 500 is designed such that message data sent in from the message analysis portion 320 (see FIG. 3) are handled, for example, in a FIFO (first-in, first-out) manner.

The contents of the supplementary data table to which the system analysis support system 201 can gain access are next described. FIG. 6 is a diagram illustrating one example of contents of the supplementary data table. In FIG. 6, the supplementary data table 600 has fields for object name, number of executions, average processing time, maximum processing time, and standard deviation. Supplementary data sets 600-1 to 600-m are stored as records by setting information in each field.

The object name is a name for identifying an object executed by the servers 203-205 at the destination of a request message. In an embodiment, contents of processing of the objects executed when various business services are offered give object names. The number of executions is the number of executions performed by the servers 203-205 for an object. The average processing time and maximum processing time are an actual time in which an object is processed by the server at the destination of a request message.

More particularly, the average processing time is the average processing time taken for the servers 203-205 to execute an object. The maximum processing time is the maximum processing time taken for the servers 203-205 to execute an object. The standard deviation is an index indicating the degree of variation of processing times taken for the servers 203-205 to execute an object.

Take the supplementary data set 600-2 as an example. A functional portion (such as updating portion 708) described later in connection with FIG. 7 can recognize the number of executions C2, average processing time T2ₐᵥₑ, maximum processing time T2ₘₐₓ, and standard deviation σ2 recording an object “ABC” by referring to the information set in each field. The contents of the records in the supplementary data table 600 are updated serially during operation of the IT system 200. The supplementary data table 600 may be built in a storage area such as the magnetic disk 405 or optical disk 407 of the system analysis support system 201. In addition, the data table may be built in external computing equipment.

The functional configuration of the system analysis support system 201 associated with an embodiment is next described. FIG. 7 is a block diagram showing the functional configuration of the system analysis support system. In FIG. 7, the support system 201 includes an acquisition portion 701, the selection portion 702, the search portion 703, a decision portion 704, a determination portion 705, a computing portion 706, an associating portion 707, the updating portion 708, and an output portion 709. While components of the system 201 are shown as separate components, the present invention is not limited to a particular configuration. For example, two or more of functions described may be implemented via a computer.

The functional portions (i.e., the acquisition portion 701 to the output portion 709) constitute a control portion. The function of the control portion is realized, for example, either by causing the CPU 401 to execute a program stored in a storage region such as the ROM 402, RAM 403, magnetic disk 405, or optical disk 407 shown in FIG. 4 or by means of the I/F 408.

The acquisition portion 701 has a function of acquiring message data passed within the handled system. The handled system undergoes analysis regarding the status of operation, and is a network system (e.g., IT system 200) where plural servers operate in cooperation. The message data passed within the system is data of a log of messages sent and received between computers within the system. The message data includes the instants at which messages were sent, message IDs, protocols, message types, and objects, for example.

In particular, the acquisition portion 701 may acquire message data analyzed by the message analysis portion 320. Furthermore, the acquisition portion 701 may receive message data from external computing equipment via the I/F 408. The acquired message data is stored, for example, in the message buffer 500 shown in FIG. 5.

The selection portion 702 has a function of selecting arbitrary request messages from the acquired message data sets. More specifically, the selection portion 702 selects arbitrary request message(s) from the message data sets 500-1 to 500-5 stored in the message buffer 500 using the message type “request” as a clue (indication). The results of the selection are stored in a storage region such as the RAM 403, magnetic disk 405, or optical disk 407 shown in FIG. 4.

The search portion 703 has a function of searching a set of message data for a response message respective to the selected request message. In particular, the search portion 703 searches the message data sets 500-1 to 500-5 for a response message having the same message ID as the request message using the message ID and message type as clue(s).

It is assumed that the selection portion 702 has selected a request message (hereinafter simply referred to as the request message M2) having message ID of M2. In this case, the search portion 703 searches the message data sets 500-1 to 500-5 for a message having message ID “M2” and message type “response”. In an embodiment, the response message M2 is found as a result of the search.

Furthermore, it is assumed that the selection portion 702 has selected a request message M3. In this case, the search portion 703 searches the message data sets 500-1 to 500-5 for a message having message ID “M3” and message type “response”. In this example, any pertinent message is not found as a result of the search. The results of the search are stored in a storage region such as the RAM 403, magnetic disk 405, or optical disk 407.

The decision portion 704 has a function of making a decision as to whether or not the actual processing time for the request message stored in a table has elapsed since the instant at which the request message was sent in a case where any pertinent response message has not been found as a result of the search. For example, this table is the supplementary data table 600 shown in FIG. 6.

For example, an actual processing time is an average processing time or a maximum processing time in which an object is executed or processed by the server to which a request message is sent as already described in connection with FIG. 6. In an embodiment, the actual processing time is a maximum processing time taken by the servers 203-205 at the destination of the request message stored in the supplementary data table 600.

A reference instant of time based on which a decision is made as to whether or not the actual processing time has elapsed from the instant of sending of the request message can also be the instant at which the newest message data stored in the message buffer 500 is sent. That is, the decision portion 704 may make a decision as to whether the maximum processing time t5 has elapsed the maximum processing time since the instant of sending of the request message. Furthermore, the present instant of time counted within the system analysis support system 201 may be used as the reference instant of time.

When the supplementary data table 600 has been initialized, any actual processing time associated with the execution of each object is not stored. In this case, an initial value or a default value may be used as the actual processing time. For example, a timeout period set intrinsically in the server at the sender of the request message may be used as the initial value.

As a specific example of the decision, a case in which a response message M3 responsive to the request message M3 has not been found as a result of the search is described. The maximum processing time taken by the server at the destination of the request message M3 is used as the actual processing time to be judged.

In this case, the decision portion 704 first gains access to the supplementary data table 600, refers to the object names of the supplementary data sets 600-1 to 600-m, and reads out the maximum processing time T3ₘₐₓ of the request message M3. In particular, the decision portion 704 reads out the maximum processing time T3ₘₐₓ using the object “SELECT uid from tbl” of the request message M3 as a clue.

Then, the decision portion 704 refers to the instants of sending of the message data sets 500-1 to 500-5 and identifies the instant of sending t5 of the newest message data set 500-5. The decision portion 704 makes a decision as to whether the instant of sending t5 is past the sum of the instant of sending t4 of the request message M3 and the maximum processing time T3ₘₐₓ, i.e., t4+T3ₘₐₓ.

The case where the instant of sending t5 is past the instant “t4+T3ₘₐₓ” refers to a case where any response message responsive to the request message M3 does not exist. That is, the AP server 204 at the sender of the request message M3 has timed out. The results of the decision are stored in a storage region such as the RAM 403, magnetic disk 405, or optical disk 407.

Where it is determined that the actual processing time has elapsed, the determination portion 705 has a function of determining an estimated instant of sending in a case where a response message responsive to the request message is assumed to have been sent. Specifically, the determination portion 705 determines an estimated instant of sending, for example, based on the instant of sending of the request message and on the actual processing time taken by the server at the destination of the request message.

More specifically, the determination portion 705 determines the estimated instant of sending, for example, by adding the average or maximum processing time taken by the server at the destination of the request message to the instant of sending of a request message. The results of the determination are stored in a storage region such as the RAM 403, magnetic disk 405, or optical disk 407.

That is, where there is not any response message responsive to the request message, an instant of sending of a response message not existing in practice is supplemented using the actual processing time taken by the server at the destination. A specific example of the determination is a case where an estimated instant of sending of a response message responsive to the request message M3 is determined using the average processing time.

In this case, the determination portion 705 first gains access to the supplementary data table 600 and reads out the average processing time T3ₐᵥₑ for the request message M3. The determination portion 705 then determines an estimated instant “t4+T3ₐᵥₑ” at which the response message is sent by adding the average processing time T3ₐᵥₑ to the instant of sending t4 of the request message M3.

The estimated instant of sending “t4+T3ₐᵥₑ” is an estimated instant of sending of the response message M3 to be sent to the AP server 204 from the DB server 205 in response to the request message M3 from the AP server 204. Consequently, the estimated instant of sending of the response message M3 not existing in practice and responsive to the request message M3 can be supplemented.

The time taken to supplement the estimated instant of sending may be found from statistical information regarding the actual processing time taken by the server about the request message. The statistical information includes the average of processing times taken by the servers associated with execution of objects, standard deviation, dispersion, median, and so on.

Specifically, the computing portion 706 has a function of calculating an estimated processing time taken by the server at the destination of the request message in a case where the decision portion 704 has determined that the actual processing time has elapsed. In this case, the determination portion 705 may determine the estimated instant of sending of a response message by adding the estimated processing time to the instant of sending of the request message.

More specifically, the computing portion 706 may calculate the estimated processing time taken by the server by multiplying a standard deviation indicating dispersion of processing times by a constant integer (e.g., 3) and adding the product to the average processing time taken by the server at the destination. The results of the calculation are stored in a storage region such as the RAM 403, magnetic disk 405, or optical disk 407.

As a specific example of the calculation, a case where an estimated processing time for a response message M3 responsive to the request message M3 is calculated is described. In this case, the computing portion 706 first gains access to the supplementary data table 600 and reads out the average processing time T3ₐᵥₑ for the request message M3 and the standard deviation σ3 using the object name as a clue.

The computing portion 706 adds three times of the standard deviation σ3 to the average processing time T3ₐᵥₑ to thereby calculate an estimated processing time “T3ₐᵥₑ+3σ3” at the DB server 205. In this case, the determination portion 705 determines an estimated instant of sending “t4+(T3ₐᵥₑ+3σ3)” of the response message M3, for example, by adding the estimated processing time “T3ₐᵥₑ+3σ3” to the instant of sending t4 of the request message M3. Consequently, the estimated instant of sending of the response message M3 can be supplemented while taking account of the statistical variation of the processing times taken by the DB server 205 to execute the object “SELECT uid from tbl”.

The associating portion 707 has a function of associating the determined, estimated instant of sending with the request message. In particular, the associating portion 707 associates the message ID, protocol, object name, and instant of sending of the request message with an estimated instant of sending of a response message not existing in practice. Consequently, with respect to a request message having any response message not existing in practice, the corresponding relation between the request instant and the response instant can be established.

Furthermore, the associating portion 707 may associate the request message and response message having a corresponding relationship. A pair of messages having a corresponding relationship may be identified by causing the search portion 703 to search message data sets for a response message responsive to a request message selected from the message data sets.

Furthermore, the response message may be identified by causing the search portion 703 to search the message data sets for the response message responsive to a response message selected from the message data sets. The results of the association are registered as new records in the pair data table 800 described later in connection with FIG. 8.

The updating portion 708 has a function of updating the actual processing time taken by the server at the destination of the request message stored in the table. In particular, the updating portion 708 updates the actual processing time taken to process the associated request message, for example, based on the instant of sending of the associated request message and on the instant of sending of the response message.

More specifically, the updating portion 708 first calculates the processing time taken by the server, for example, by subtracting the instant of sending of the request message from the instant of sending of the response message. Using the processing time, the updating portion 708 updates the average processing time and the maximum processing time stored in the supplementary data table 600.

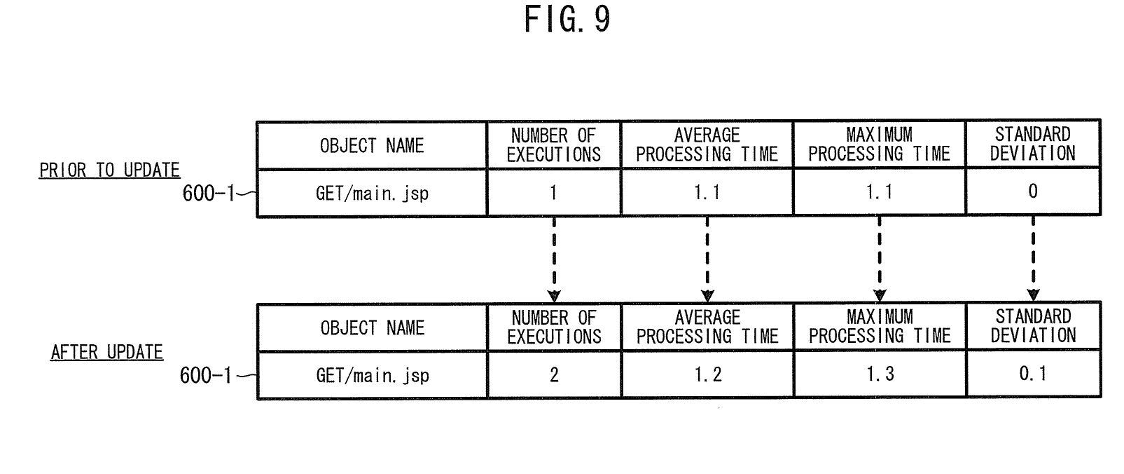

An update process by the updating portion 708 is done, for example, whenever a request message and a response message having a corresponding relationship are associated. Consequently, the actual processing time taken to execute each object can be updated successively according to the status of operation of the IT system 200. The contents of the update process are described later in further detail by referring to FIG. 9.

The contents of the pair data table 800 are described. FIG. 8 illustrates one example of the contents of the pair data table. In FIG. 8, the pair data table 800 has fields for pair ID, supplement flag, message ID, protocol, object name, request instant, and response instant. Pair data sets 800-1 to 800-n are stored as records by setting information in each field.

The pair ID is an identifier for identifying a pair of a request and a response. The supplement flag is a flag used to identify a pair having no response message. In an embodiment, a supplement flag for a pair having no response message (i.e., the instant of sending of the response message has been supplemented) is ON.

The object name is a name for identifying an object. The request instant is the instant of sending of a request message. The response instant is the instant at which the request response was sent or an estimated instant of sending.

For example, it is possible to recognize the corresponding relationship between the request instant t3 of object “ABC” and the response time t5 by referring to information set in each field for the pair data set 800-1. Furthermore, it is possible to recognize from the protocol “IIOP” that messages have been transmitted between the Web server 203 and the AP server 204.

In addition, the corresponding relationship between the request instant t4 of the object “SELECT uid from tbl” and the response instant “t4+T3ₐᵥₑ” can be recognized by referring to the information set in each field for the pair data set 800-2. Further, it is possible to recognize from the protocol “SQL” that messages have been passed between the AP server 204 and the DB server 205. Note that the response instant “t4+T3ₐᵥₑ” is an estimated instant of sending of the response message M3 not existing in practice.

The output portion 709 has a function of outputting the results of the association. In particular, for example, the output portion 709 outputs the contents of records in the pair data table 800 to the I/F 408. The output format can be display provided on a display device, printing output to a printer, or sending to an external device via the I/F 408. Additionally, the results may be stored in a storage area such as the RAM 403, magnetic disk 405, and optical disk 407.

The output portion 709 may output the actual processing time taken by the server at the destination of the updated request message. In particular, for example, the output portion 709 outputs the contents of the records in the updated supplementary data table 600 to the I/F 408.

The contents of the update process performed by the updating portion 708 are described in detail. An example is taken in which request message M1 and response message M1 having a corresponding relationship are associated with each other and thus the supplementary data set 600-1 stored in the supplementary data table 600 is updated. FIG. 9 schematically illustrates the update process.

Prior to updating, the average processing time T1ₐᵥₑ taken by the Web server 203 to execute an object “GET/main.jsp” is 1.1 sec, and the maximum processing time T1 max is 1.1 sec. The standard deviation σ1 is 0. It is assumed that the request message M1 and response message M1 having a corresponding relationship are associated with each other. Note that the instant of sending of the response message M1 is t6.

In this case, the updating portion 708 calculates the processing time taken by the Web server 203 to execute the object “GET/main.jsp” by subtracting the instant of sending t1 of the request message M2 from the instant of sending t6 of the response message M1. In this example, it is assumed that the processing time is 1.3 sec.

Then, the updating portion 708 finds the updated average processing time T1ₐᵥₑ taken after the updating, for example, using the following Eq. (1).

$${Ti}_{ave} = \frac{{T}^{′} {i}_{ave} \times Ci + X}{Ci + 1} \qquad ( 1 )$$

where Tiₐᵥₑ is the average processing time taken after updating, T′iₐᵥₑ is the average processing time taken prior to the updating, Ci is the number of executions for an object prior to the updating, and X is the processing time taken to execute the object at this time (i=1, 2, . . . , m).

In this example, the average processing time Tiₐᵥₑ taken after updating is “T1ₐᵥₑ=(1.1×1+1.3)/(1+1)=1.2”. In this case, the updating portion 708 rewrites the average processing time T1ₐᵥₑ for the supplementary data set 600-1 from 1.1 to 1.2.

The updating portion 708 compares the processing time X (X=1.3) taken to execute the object at this time with the maximum processing time T1ₘₐₓ taken prior to updating and determines the maximum processing time T1ₘₐₓ taken after the updating. In this example, the processing time X is longer than the maximum processing time T1ₘₐₓ taken prior to updating. In this case, the updating portion 708 rewrites the maximum processing time T1ₘₐₓ about the supplementary data set 600-1 from 1.1 to 1.3.

The updating portion 708 calculates the standard deviational obtained after updating, using the average processing time T1ₐᵥₑ taken after the updating and the processing time X. In particular, the standard deviation σ1 obtained after updating is computed by taking the difference between the average processing time T1ₐᵥₑ taken after the updating and the processing time X, squaring the difference, and taking the square root. In this example, the standard deviation σ1 obtained after updating is 0.1. In this case, the updating portion 708 rewrites the standard deviation σ1 for the supplementary data set 600-1 from 0 to 0.1.

Whenever paired messages having a corresponding relationship are associated with each other, the updating is done. Thus, it is possible to update the information set in the fields for the supplementary data sets 600-1 to 600-m according to the status of operation of the IT system 200. Past processing times necessary to find the standard deviation σi are stored, for example, in the supplementary data table 600 in a manner not illustrated.

The procedure of system analysis support provided by the system analysis support system 201 is next described. In this example, a procedure of system analysis support automatically provided when message data is acquired is described. Prior to implementation of the system analysis support, the supplementary data table 600 is initialized. In particular, initial value “0” is set, for example, in the fields for number of executions, average processing time, and maximum processing time.

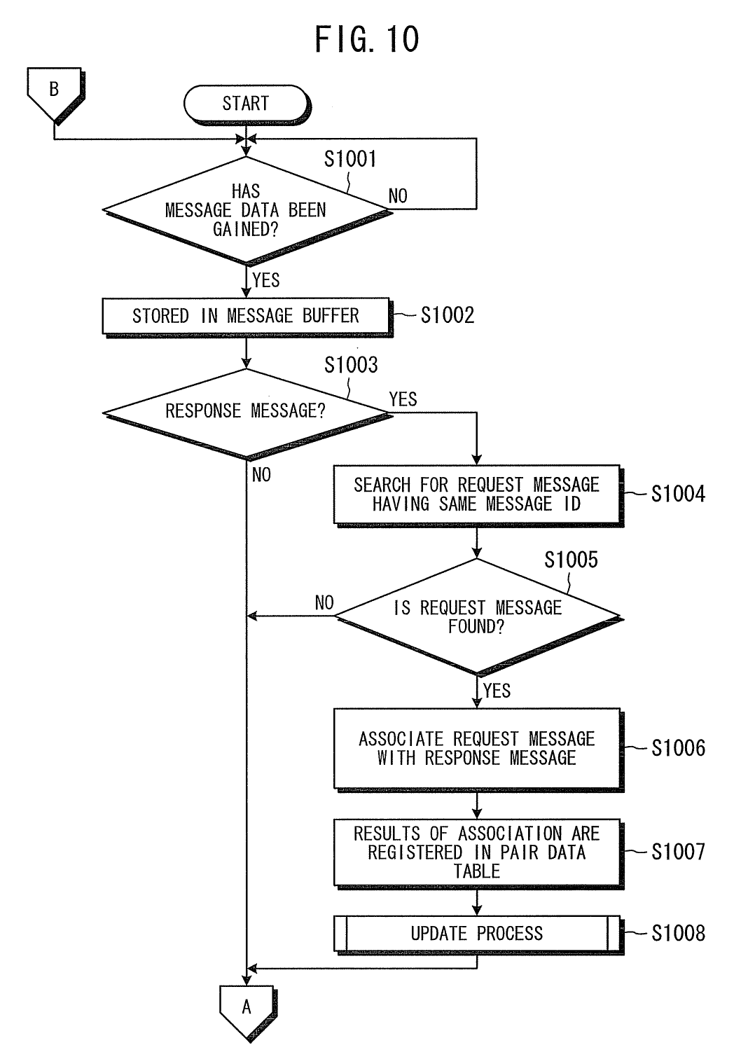

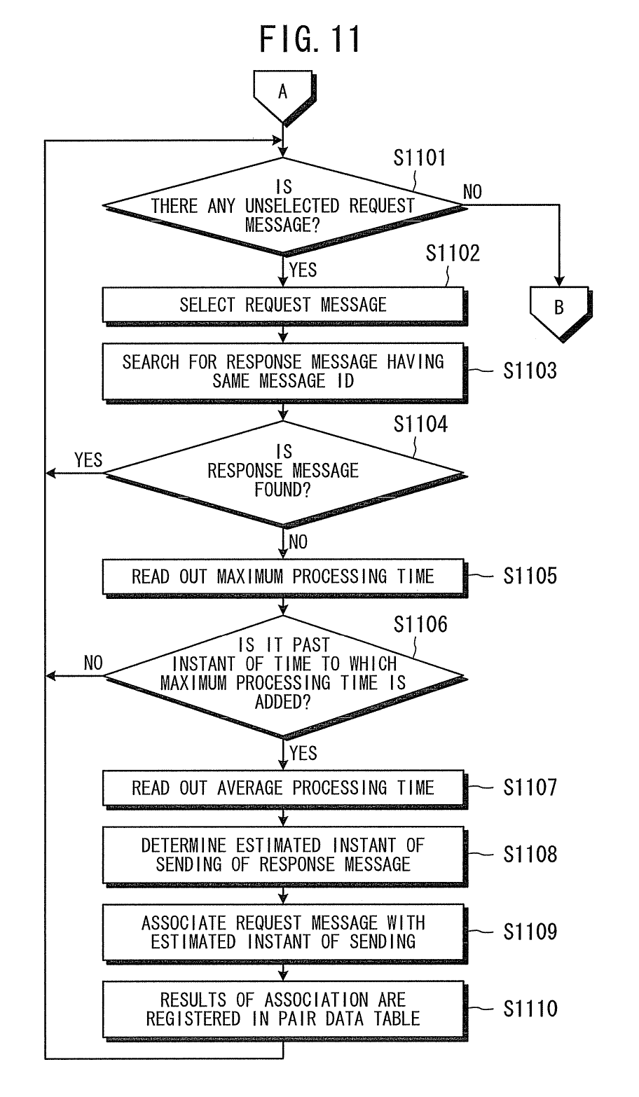

FIGS. 10 and 11 are flowcharts illustrating one example of procedure for providing system analysis support. In the flowchart of FIG. 10, the acquisition portion 701, for example, first makes a decision as to whether message data has been acquired (gained) (operation S1001). If the system waits and acquires message data (No at operation S1001) or if the system acquires message data (Yes at operation S1001), the message data is stored in the message buffer 500 (operation S1002).

Then, the search portion 703, for example, refers to the message type of the acquired message data and makes a decision as to whether or not the message is a response message (operation S1003). Where the message is a response message (No at operation S1003), program control goes to operation S1101 illustrated in FIG. 11.

On the other hand, if the message is a response message (Yes at operation S1003), the search portion 703 searches the message buffer 500 for a request message having the same message ID as the message ID of the response message (operation S1004). The search portion 703 then makes a decision as to whether the request message is found as a result of the search (operation S1005).

If the request message is found as a result of the search (Yes at operation S1005), the associating portion 707, for example, associates the request message and response message (operation S1006). The associating portion 707 causes the results of the association to be registered as pair information in the pair data table 800 (operation S1007).

Then, the updating portion 708, for example, carries out an update process for updating the contents of the supplementary data table 600 (operation S1008), and program control proceeds to the operation S1101 illustrated in FIG. 11. If the pertinent request message is not found as a result of the search in operation S1005 (No at operation S1005), program control goes to operation S1101 illustrated in FIG. 11.

In the flowchart of FIG. 11, the selection portion 702, for example, first makes a decision as to whether or not there is any unselected request message in the message buffer 500 (operation S1101). If there is any unselected request message (Yes at operation S1101), the selection portion 702 selects (an arbitrary) request message from the message buffer 500 using the message type “request” as a clue (operation S1102).

The search portion 703, for example, searches the message buffer 500 for a response message having the same message ID as the message ID of the selected request message (operation S1103). Then, the search portion 703 makes a decision as to whether or not a pertinent response message is found as a result of the search (operation S1104).

If a pertinent response message is found as a result of the search (Yes at operation S1104), program control returns to operation S1101. On the other hand, if any pertinent response message is not found (No at operation S1104), the decision portion 704 gains access to the supplementary data table 600 and reads the maximum processing time taken by the server at the destination of the request-message selected in operation S1102 (operation S1105).

The decision portion 704, for example, makes a decision as to whether the instant of sending of the newest message data stored in the message buffer 500 is past the sum of the instant of sending of the request message and the maximum processing time (operation S1106). If the former instant of sending is not past the sum (No at operation S1106), program control returns to operation S1101.

On the other hand, if the former instant of sending is past (Yes at S1106), the determination portion 705 gains access to the supplementary data table 600 and reads the average processing time taken by the server at the destination of the request message selected at operation S1102 (operation S1107). The determination portion 705 determines the sum of the instant of sending of the request message and the average processing time as an estimated instant of sending of a response message (operation S1108).

Then, the associating portion 707, for example, associates the request message with the estimated instant of sending of the response message (operation S1109). The associating portion 707, for example, causes the results of the association to be registered as pair information in the pair data table 800 (operation S1110), and program control returns to operation S1101. If there is not any unselected request message in operation S1101 (No at operation S1101), program control goes back to operation S1001 illustrated in FIG. 10.

Consequently, with respect to request messages including request messages having no pertinent response messages; it is possible to collect pair information indicating corresponding relationships between request instants and response instants. Pair information can be collected in real time, i.e., during operation of the IT system 200, by executing the aforementioned sequence of operations at the time when message data is acquired.

The contents of the records in the pair data table 800 can be output in arbitrary format by entering an instruction for outputting of pair information at arbitrary timing during execution of the sequence of operations.

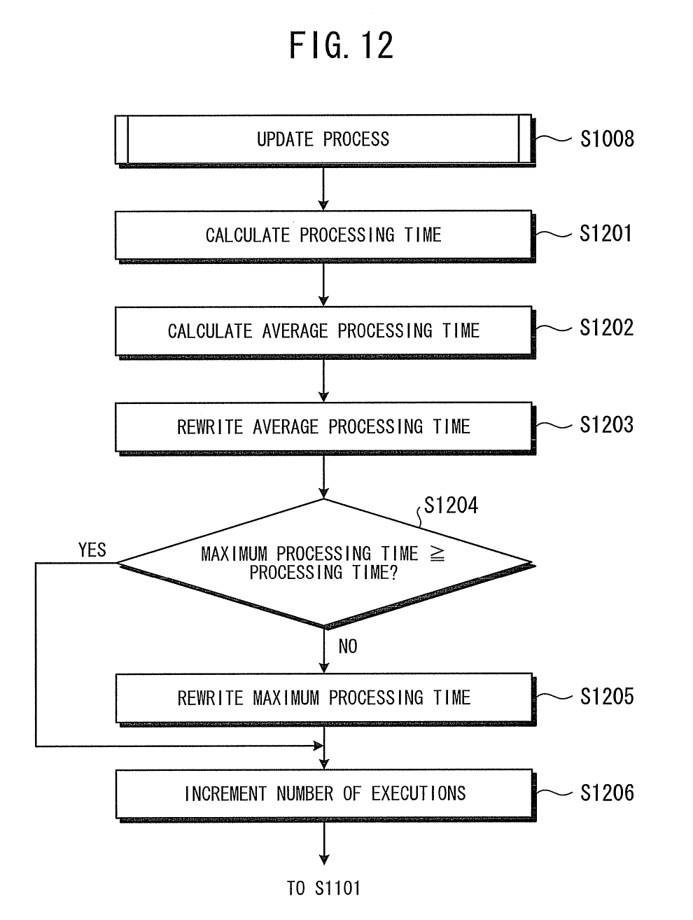

The procedure of the update process done in operation S1008 illustrated in FIG. 10 is next described in detail. A case where a number of executions, an average processing time, and a maximum processing time in the fields possessed by the supplementary data table 600 are updated is described. FIG. 12 is a flowchart illustrating one specific example of the procedure of the update process.

In the flowchart of FIG. 12, the updating portion 708, for example, first calculates the processing time taken by the server at the destination of the request message found as a result of the search at operation S1004 illustrated in FIG. 10 (operation S1201). In particular, the processing time is calculated by subtracting the instant of sending of the request message from the instant of sending of the response message associated at operation S1006 illustrated in FIG. 10.

Then, the average processing time obtained after updating is calculated by gaining access to the supplementary data table 600 and substituting the average processing time, number of executions, and processing time about the pertinent record into Eq. (1) above (operation S1202). The pertinent record is identified from the object of the request message found as a result of the search made at operation S1004. The average processing time for the pertinent record in the supplementary data table 600 is rewritten into the calculated average processing time (operation S1203).

Then, a decision is made as to whether the maximum processing time about the pertinent record in the supplementary data table 600 is equal to or longer than the above-described processing time (operation S1204). If the maximum processing time is shorter than the processing time (No at operation S1204), the maximum processing time of the record is rewritten into the processing time (operation S1205).

Finally, a number of executions for the pertinent record in the supplementary data table 600 is incremented (operation S1206), and program control goes to operation S1101 illustrated in FIG. 11. If the maximum processing time is equal to or longer than the processing time (Yes at operation S1204), the number of executions for the record is incremented (operation S1206) and control program proceeds to operation S1101 illustrated in FIG. 11.

Consequently, the average processing time and the maximum processing time associated with the execution of each object stored in the supplementary data table 600 can be updated successively according to the status of operation of the IT system 200.

In the example shown in FIGS. 10 and 11, the processing for system analysis support is performed when message data is acquired. The invention is not limited to this method. For example, the processing for system analysis support can be carried out by causing message data sets passed within the IT system 200 for a given period (such as 24 hours or 1 week) to be given in a batch to the system analysis support system 201.

In this case, if any response message responsive to the request message is not found in the message data sets, the request message can be treated as having no response message. That is, processing operations corresponding to the operations S1105 and S1106 illustrated in FIG. 11 can be omitted.

However, message data sets include a request message issued immediately before the end of a certain period. There is the possibility that a response message responsive to this request message is issued after the end of the certain period. However, such message pairs are so small compared with all the messages that they can be neglected. Therefore, failure to grasp such message pairs little affects the accuracy at which the status of operation of the IT system 200 is analyzed.

Message data sets passed within the IT system 200 during a certain period are stored in a message database (DB) having data structure similar to the data structure of the message buffer 500 shown in FIG. 5 in a manner not illustrated. The message DB is built, for example, in a storage region such as the magnetic disk 405 or optical disk 407 of the system analysis support system 201.

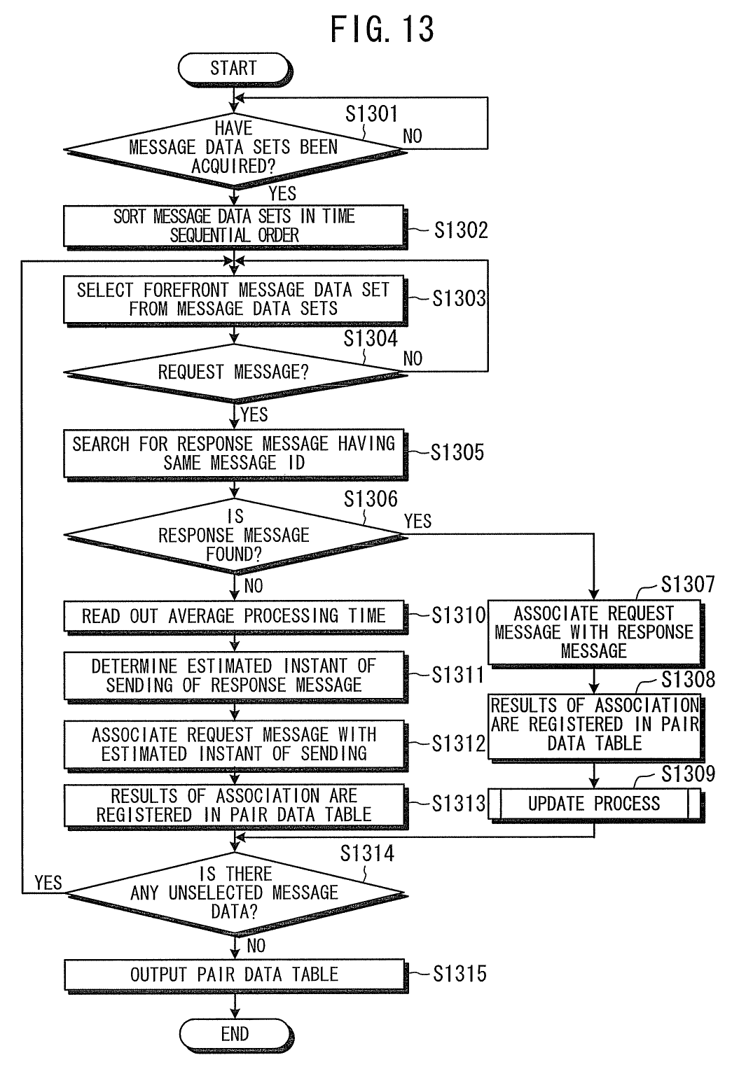

The procedure of the processing for providing the system analysis support is described below, the processing being carried out by causing the message data sets passed within the IT system 200 during a certain period to be given in a batch to the system analysis support system 201. FIG. 13 is a third flowchart illustrating one example of the procedure of the processing for providing the system analysis support.

In the flowchart of FIG. 13, the acquisition portion 701, for example, first makes a decision as to whether or not message data sets have been acquired (operation S1301). If the decision at operation S1301 is No and if a re-decision at operation S1301 is Yes (acquired successfully), the message data sets are sorted in a time sequential order (operation S1302).

Then, the selection portion 702, for example, selects the forefront message data set from the message data sets sorted in a time sequential order (operation S1303). The search portion 703, for example refers to the message type of the selected message data set and makes a decision as to whether it is a request message (operation S1304). If it is a response message (No at operation S1304), program control returns to operation S1303.

On the other hand, if the message is a request message (Yes at operation S1304), the search portion 703 searches the message data sets for a response message having the same message ID as the message ID of the request message (operation S1305) and makes a decision as to whether or not a pertinent response message is found as a result of the search (operation S1306).

If the pertinent response message is found as a result of the search (Yes at operation S1306), the associating portion 707 associates the request message with the response message (operation S1307). Then, the associating portion 707 registers the results of the association as pair information into the pair data table 800 (operation S1308). Thereafter, the updating portion 708 performs the processing for updating the contents of the supplementary data table 600 (operation S1309) and then control program goes to operation S1314. Details of the procedure of the processing for the updating are the same as those of the procedure illustrated in FIG. 10 and so their description is omitted.

If any pertinent response message is not found as a result of the search at operation S1306 (No at operation S1306), the determination portion 705 gains access to the supplementary data table 600 and reads out the average processing time taken by the server at the destination of the selected request message (operation S1310). The determination portion 705 determines the sum of the instant of sending of the request message and the average processing time as an estimated instant of sending of a response message (operation S1311).

Then, the associating portion 707 associates the request message with the estimated instant of sending of the response message (operation S1312). The associating portion 707 causes the results of the association to be registered as pair information into the pair data table 800 (operation S1313). The selection portion 702 then makes a decision as to whether there is any unselected message in the message data sets (operation S1314).

If there is any unselected message data (Yes at operation S1314), program control returns to the operation S1303. The selection portion 702 selects the forefront message data set from the unselected message data sets. On the other hand, if there is not any unselected message data (No at operation S1314), the output portion 709 outputs the contents of the records in the pair data table 800 (operation S1315). A sequence of processing operations of the present flowchart is terminated.

Consequently, with respect to request messages (including ones having no response messages) passed within the IT system 200 during a certain period, pair information indicating a corresponding relationship between the request instant and the response instant can be offered.

As described so far, according to an embodiment, it is possible to supplement an estimated instant of sending of a response message which is paired with a request message but does not exist in practice, using an actual processing time taken by a server at the destination of the request. In consequence, with respect to a request message having no response message, a corresponding relationship between the request instant and the response instant can be built.

By building a corresponding relationship between a request instant and a response instant, it is possible to judge the nested relationship of messages of a pair between hierarchical layers. Transaction(s) including timeouts can be grasped. As a result, when a timeout takes place, it is possible to analyze how the business service is being processed. Hence, the accuracy at which the status of operation of the system to be handled is analyzed can be improved.

An example of application of pair information (such as the pair data sets 800-1 to 800-n shown in FIG. 8) obtained by the present technique of system analysis support is hereinafter described. Pair information obtained by the present technique of system analysis support can be applied to the typical system visualization technology. Especially, it is possible to analyze how transactions including timeouts are being processed, using estimated instants of sending of response message not existing in practice.

Transactions including timeouts are described while taking the pair data sets 800-1 to 800-3 as an example. Messages are sent at instants of time t2-t6 (hour: minute: second), which are assumed to be “00:00:00.100”, “00:00:00.150”, “00:00:00.190”, “00:00:00.250”, and “00:00:00.300”, respectively. It is also assumed that the average processing time T3ₐᵥₑ is 20 msec.

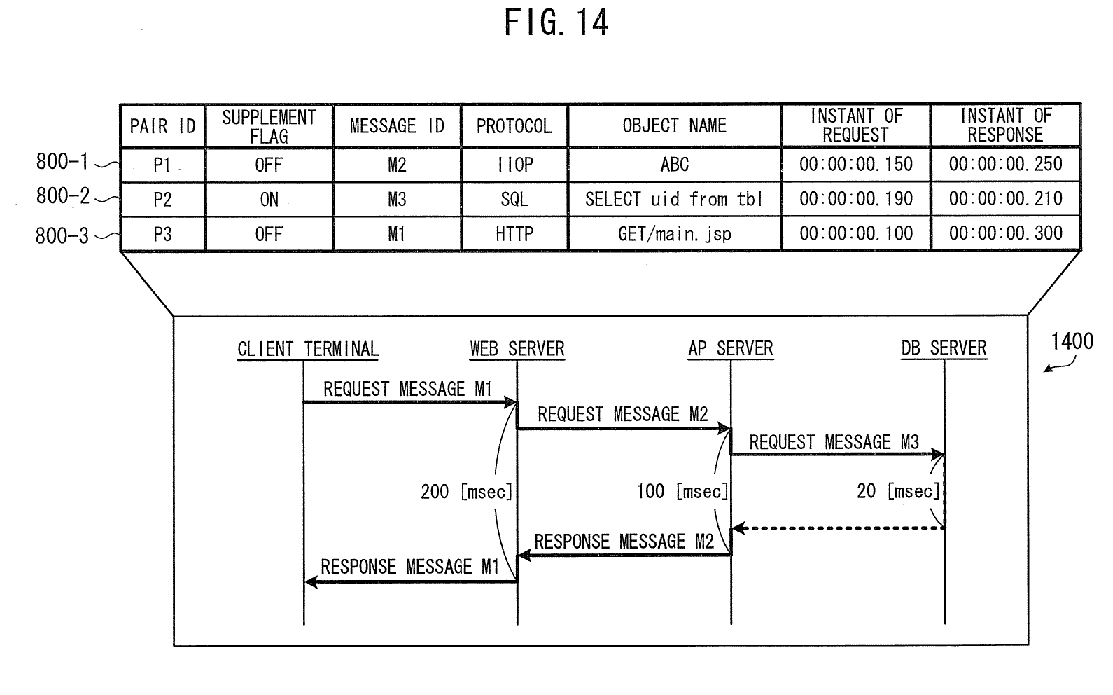

FIG. 14 is a diagram illustrating a specific example of a transaction including a timeout. In FIG. 14, a graph 1400 indicates a time sequential flow of messages passed within the IT system 200 during the transaction including a timeout. In order to grasp the transaction, it is necessary for a computer for realizing a system visualization technique to grasp the nested relationship of messages of a pair between different layers of hierarchy.

In this example, the computer refers to the pair data sets 800-1 and 800-3 and recognizes the nested relationship of the messages of a pair between the Web layer and the AP layer. Specifically, the computer recognizes that a request message M2 and a response message M2 in the AP layer are sandwiched between a request message M1 and a response message M1 in the Web layer.

The computer also refers to the pair data sets 800-1 and 800-2 and recognizes the nested relationship of messages of a pair between the AP layer and the DB layer. In particular, the computer recognizes that a request message M3 and a response message M3 in the DB layer are sandwiched between the request message M2 and response message M2 in the AP layer. Furthermore, the computer can recognize that the response message M3 does not exist in practice by referring to the supplement flag for the pair data set 800-2.

Additionally, it is possible to calculate the processing times taken by the servers 203-205, respectively, during the execution of the transaction by referring to the instant of each request and the instant of the response about the pair data sets 800-1 to 800-3. In this example, the processing time taken by the Web server 203 is 200 msec. The processing time taken by the AP server 204 is 100 msec. The processing time taken by the DB server 205 is 20 msec.

In this way, the pair data sets 800-1 to 800-3 make it possible to judge the nested relationship of messages of a pair between layers of hierarchy. Transactions including timeouts can be grasped. Especially, the nested relationship of messages of a pair between the AP layer and the DB layer can be judged using an estimated instant of sending of the response message M3 not existing in practice.

Messages can be matched with a transactional model using pair information obtained by the present technique of system analysis support by the typical art matching method. However, the transactional model used in the present technique providing system analysis support is different in format of expression from the typical transactional model. The transactional model used in the present technique of system analysis support is described.

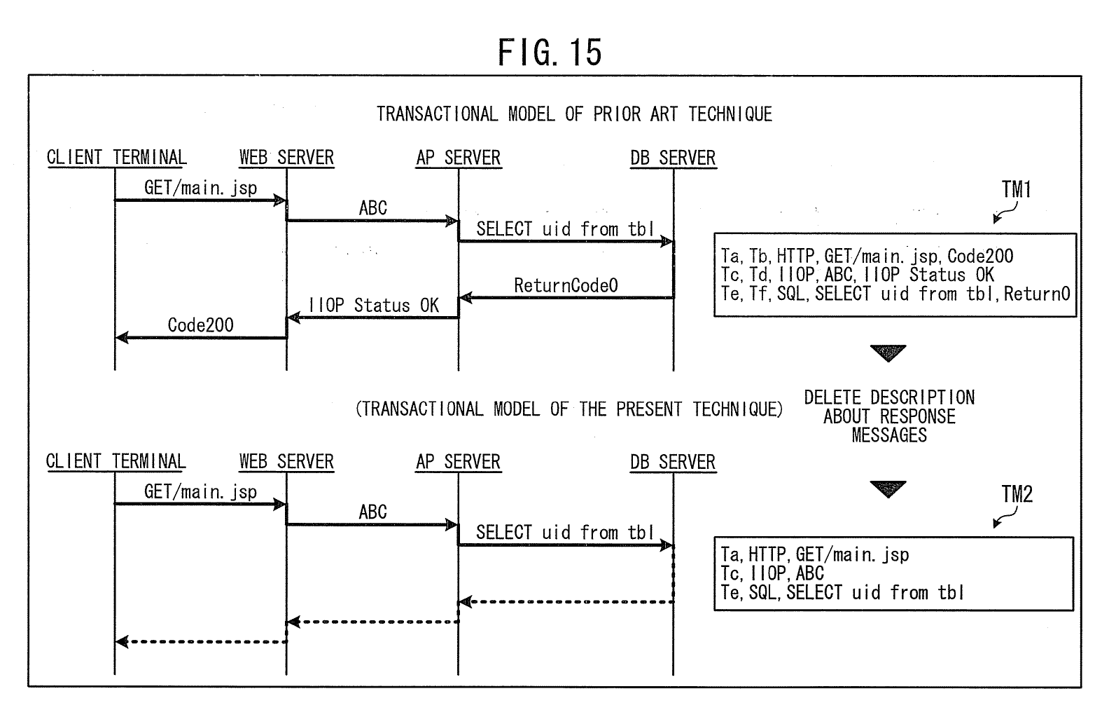

FIG. 15 is a diagram illustrating an example of generation of a transactional model. In FIG. 15, the transactional model TM1 is a transactional model represented in the typical format. The model TM1 is expressed on the assumption that there is a message pair having of a request message and a response message.

Specifically, in the transactional model TM1, an HTTP message “GET/main.jsp” has a request instant of Ta and a response instant of Tb. “Code200” indicates a return value indicating that an HTTP has been acquired normally. An IIOP message “ABC” called from the HTTP message “GET/main.jsp” has a request instant of Tc and a response instant of Td.

An SQL message “SELECT uid from tbl” called from the IIOP message “ABC” has a request instant of Te and a response instant of Tf. In this case, with respect to the instants of time Ta to Tf, the following restrictions hold: Ta<Tc, Td<Tb, Tc<Te, and Tf<Td. That is, in this format of expression, if there is no response message, coincidence with the transactional model TM1 does not take place and hence this format of expression cannot be treated.

Accordingly, with the transactional model TM2 used in the present technique of system analysis support, only a request message is defined for each protocol. For example, with respect to the HTTP message “GET/main.jsp”, only the request instant Ta is defined. The transactional model TM2 can be created by deleting description regarding the response message from the transactional model TM1.

Messages passed within the IT system 200 are matched with the transactional model TM2. At this time, messages matched with the model TM2 are only request messages. Accordingly, the nested relationship of messages of a pair between layers of hierarchy is recognized using pair information obtained by the present technique for system analysis support. Consequently, it is possible to analyze how transactions including timeouts are processed.

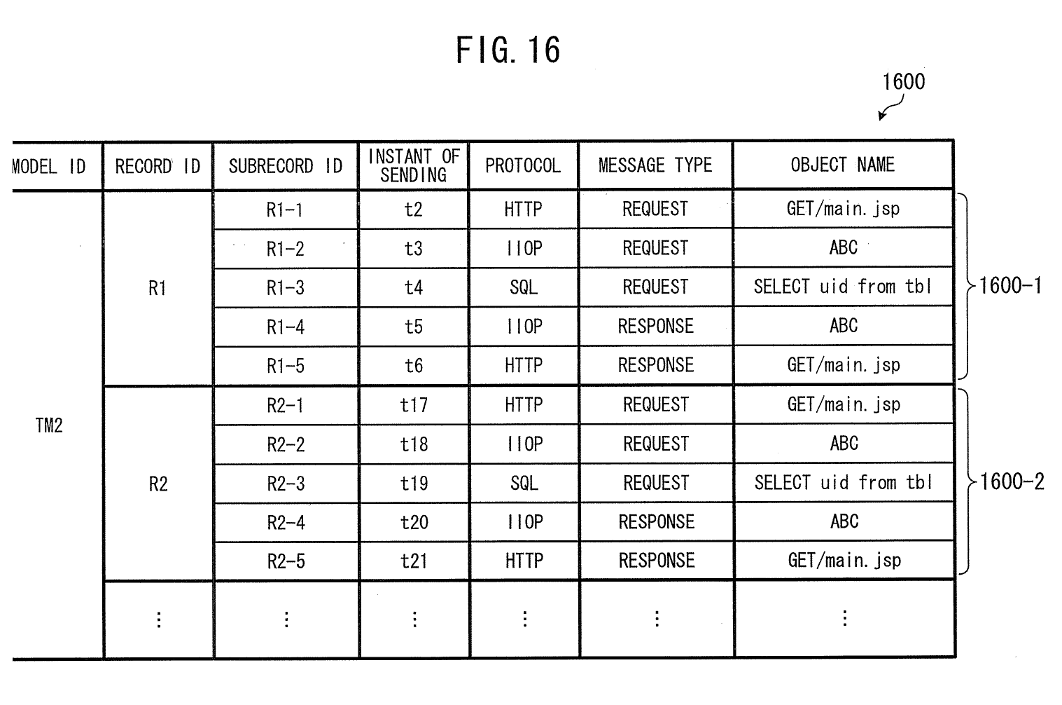

The results of matching made using the transactional model TM2 are described now. FIG. 16 is a diagram illustrating a specific example of matching results. In FIG. 16, the matching results 1600 have fields for model ID, record ID, subrecord ID, instant of sending, protocol, message type, and object name. Transaction information (such as transaction data sets 1600-1 and 1600-2) is stored as records by setting information in the fields.

The model ID is an identifier for identifying a transactional model. The record ID is an identifier for identifying a matching result. The subrecord ID is an identifier for identifying a message contained in a transactional model. In the matching results 1600, messages having estimated instants of sending which have been supplemented (i.e., response messages not existing in practice) are not displayed.

A user (e.g., the administrator of the IT system 200) can grasp how transactions including timeouts are produced by referring to the matching results 1600. For example, the transaction data set 1600-1 makes it possible to recognize the instant of generation t2 of a transaction including a timeout, the instant of sending t4 of the request message M3 for a process that has timed out, the AP server 204 made to time out, and so on.

The results of matching with the transactional model are not restricted to the example shown in FIG. 16. Alternatively, the results of matching performed in each certain period (such as 24 hours) may be totalized and the number of matches for each transactional model may be output. Consequently, it is possible to grasp how many transactions including timeouts took place during a certain period.

Furthermore, the ratio of the number of matches with the transactional model TM1 (see FIG. 15) to the number of matches with the transactional model TM2 may be entered. As a consequence, it is possible to grasp, for example, the ratio of transactions resulting in timeout to all of money deposit transactions executed by online banking.

Furthermore, matching results obtained for a certain period may be totalized, the average of processing times taken by each of the servers 203-205 may be calculated for each business service unit, and the results may be drawn up as a sequential graph as shown in FIG. 14. At this time, with respect to transactions including timeouts, processing times taken by the servers 203-205 can be calculated using estimated instants of sending.

As a result, when a business service is offered, the processing times taken by the servers 203-205 can be precisely grasped. The behavior of transactions executed by the servers 203-205 operating in cooperation is presented in a form easily understandable for the human. Consequently, problems hidden in the IT system 200 can be quickly grasped and appropriately dealt with.

In summary, the disclosed technique can supplement an estimated instant of sending of a response message which does not exist in practice but would be paired with a request message, using the actual time taken by the server at the destination of the request to perform processing.

How transactions including timeouts are being processed can be grasped precisely, and the accuracy at which the status of operation of a system of interest can be improved. Further, determination of whether a time has lapsed from a time at which a request message is sent may be based on a factor including an actual processing time, an average time for processing, a maximum time needed for processing and/or a specified time set by an administrator. An embodiment thus enables generating a supplemental response to a message at an estimate time period and causing the system to recognize that the supplemental response is an expected response to the request.

The method of system analysis support described in an embodiment can be implemented by executing a previously prepared program by means of a computer such as a personal computer or workstation. The program is recorded on a computer-readable storage medium such as hard disk, flexible disk, CD-ROM, MO, or DVD. The program is run by reading it from the storage medium by the computer. The program may be distributed via a network such as the Internet.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A computer-readable storage medium encoded with a system analysis support program containing instructions causing a computer acting to support analysis of status of operation of a network system including plural servers operating in cooperation to execute an operation, comprising:
searching message data sets passed within the network system for a response message responsive to a request message;
reading an actual processing time taken by a server at a destination of a request server when the response message is not found as a result of the searching;
making a decision from an instant of sending the request message as to whether the actual processing time for the request message has elapsed;
determining an estimated instant of sending, when judging that the actual processing time has elapsed, based on the instant of sending the request message and on the actual processing time, on the assumption that the response message has been sent;
associating the determined estimated instant of sending with the request message; and
outputting results of the association.

2. The computer-readable storage medium according to claim 1, wherein the actual processing time is a maximum processing time taken by the server at the destination of the request message.

3. The computer-readable storage medium according to claim 1, wherein the actual processing time is an average processing time taken by the server at the destination of the request message.

4. The computer-readable storage medium according to claim 1, wherein the determining determines a sum of the instant of sending of the request message and the actual processing time as the estimated instant of sending.

5. The computer-readable storage medium according to claim 1, comprising:
calculating an estimated processing time taken by the server at the destination of the request message when judging that the actual processing time has elapsed; and
wherein statistical information about the actual processing time taken by the server at the destination of the request message is stored
wherein the estimated processing time taken by the server is calculated based on the actual processing time taken by the server at the destination of the request message stored and on the statistical information about the actual processing time, and
wherein the determining determines a sum of the instant of sending of the request message and the calculated estimated processing time as the estimated instant of sending.

6. The computer-readable storage medium according to claim 5, wherein the calculating calculates the estimated processing time taken by the server by adding a standard deviation indicating variation of the processing time to the processing time taken by the server at the destination of the request message.

7. The computer-readable storage medium according to claim 1, wherein when the response message is not found by the searching, a decision is made as to whether an instant of sending of a newest one of the message data sets is past a sum of the instant of sending of the request message and the actual processing time.

8. The computer-readable storage medium according to claim 1, comprising:
updating the actual processing time taken to process the request message stored;
wherein the associating associates a request message and a response message having a corresponding relationship, and
wherein the updating updates the actual processing time taken to process the request message based on an instant of sending of the associated request message and on an instant of sending of the associated response message.

9. A system analysis support system for supporting analysis of status of operation of a network system in which plural servers operate in cooperation, the system comprising:
a storage unit for storing an actual processing time taken by a server at a destination of a request message passed within the network system;
a search unit for searching message data sets passed within the network system for a response message responsive to the request message;
a decision unit which, when the response message is not found as a result of the search, reads the actual processing time from the storage unit and makes a decision from an instant of sending of the request message as to whether the actual processing time for the request message has elapsed;
a determination unit which, when the actual processing time is judged to have elapsed, determines an estimated instant of sending based on the instant of sending of the request message and on the actual processing time on the assumption that the response message has been sent;
an associating unit for associating the determined estimated instant of sending with the request message; and
an output unit for outputting results of the association.

10. A method of system analysis support implemented by a computer, the method comprising:
searching message data sets passed within a network system having plural servers operating in cooperation for a response message responsive to a request message;
reading an actual processing time taken by a server at a destination of the request message from a table in which the actual processing time is stored when determining that the response message is not found as a result of the search;
making a decision from an instant of sending of the request message as to whether the actual processing time for the request message has elapsed;
determining an estimated instant of sending based on the instant of sending of the request message and on the actual processing time on the assumption that the response message has been sent when determining that the actual processing time is judged to have elapsed;
associating the determined estimated instant of sending with the request message; and
outputting results of the association.
